(19) United States
(12) Patent Application Publication
(10) Pub. No.: US 2015/0081505 A1
(43) Pub. Date: Mar. 19, 2015

(54) Detection of Potential Abusive Trading Behavior in Electronic Markets

(71) Applicant: Chicago Mercantile Exchange Inc., Chicago, IL (US)

(72) Inventors: Richard Co, Chicago, IL (US); Jason Berkowitz, Highland Park, IL (US); Jabir Patel, Morton Grove, IL (US); John Labuszewski, Westmont, IL (US); John Nyhoff, Darien, IL (US); John Kerpel, Chicago, IL (US)

(73) Assignee: Chicago Mercantile Exchange Inc., Chicago, IL (US)

(21) Appl. No.: 14/031,843

(22) Filed: Sep. 19, 2013

(51) Int. Cl. G06Q 40/04

(52) U.S. Cl. CPC G06Q 40/04
USPC 705/37

(57) ABSTRACT

Methods for detecting potential abusive trading behavior in an electronic market include: (a) querying a database in response to an alert signifying a possible trading irregularity, wherein the database is configured to store data mined from one or a plurality of electronic social media platforms; (b) determining whether the database contains evidence of a news event that explains the trading irregularity and, if so, whether the news event corresponds to fundamental and/or technical market activity; and (c) flagging the trading irregularity as potential abusive trading behavior if the database contains evidence of the news event but it is determined that the news event does not correspond to fundamental and/or technical market activity. Systems for detecting potential abusive trading behavior in an electronic market are described.

### BACKGROUND

Financial instruments are tradable assets that may be broadly classified into two groups: cash instruments (e.g., securities, loans, deposits, etc.) and derivatives. A derivative is a type of financial instrument that derives its value from the value of an underlying entity, such as a physical commodity (e.g., agricultural products, mined resources, etc.) or another financial instrument (e.g., stocks, bonds, currencies, interest rates, financial indices, etc.). Derivatives may be broadly classified into two groups: (1) exchange-traded derivatives (e.g., futures, options on futures, etc.), which are traded on a futures exchange (Exchange); and (2) over-the-counter (OTC) derivatives (e.g., forwards, swaps, etc.), which are bilateral contracts privately traded between two parties without supervision from an Exchange.

The Chicago Mercantile Exchange Inc. (CME) is one example of an Exchange, which provides a contract market where financial instruments, such as futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time.

In contrast to a futures contract, an option is the right, but not the obligation, to sell or buy the underlying instrument (e.g., a futures contract) at a specified price within a specified time. The commodity to be delivered in fulfillment of the contract or, alternatively, the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement (e.g., cash settlement, physical sale and purchase of the underlying reference commodity, etc.).

In the case of exchange-traded derivatives, an Exchange typically provides for a centralized “Clearing House” through which all trades made must be confirmed, matched, and settled each day until offset or delivered. The Clearing House is an adjunct to the Exchange, and may be an operating division of the Exchange, which is responsible for settling trading accounts, clearing trades, collecting and maintaining performance bond funds, regulating delivery, and reporting trading data. Clearing is the procedure through which the Clearing House becomes buyer to each seller of a futures contract and seller to each buyer (also known as novation), and assumes responsibility for protecting buyers and sellers from financial loss due to breach of contract by assuring performance on each contract. A Clearing Member is a firm qualified to clear trades through the Clearing House.

High-frequency trading (HFT) refers to the use of sophisticated computer algorithms to rapidly trade financial instruments in an electronic market. Traders engaged in HFT typically move in and out of positions within seconds or mere fractions of a second. As a result of its algorithmic nature, the practice of HFT is susceptible to abuse. For example, an order submitted by an abusive trader may not constitute a bona fide order to trade but rather an attempt to manipulate the electronic market for financial gain.

Various types of abusive trading techniques have been employed in efforts to gain financial advantage through market manipulation, including but not limited to spoofing, flickering (e.g., when a trader puts in an order and cancels it before anyone can act on it), flipping (e.g., when a trader plays both sides of a market, flickering one side and filling the other), layering, latency periods, quote stuffing, order book fade, momentum ignition, and the like, and combinations thereof. One such abusive practice—commonly referred to as “spoofing”—was outlawed in 2010 by the Dodd-Frank Wall Street Reform and Consumer Protection Act. The term “spoofing” (a.k.a. messaging practice abuse) may be used to describe a sham order placed by a market participant who does not have the intent to trade said order but rather who seeks to manipulate other market participants (e.g., via automated trading systems) into placing orders that the abusive trader can then use to obtain a favorable fill on a bona fide order.

Heretofore, detection of abusive trading behavior has been extremely time-consuming and involved labor-intensive manual examination techniques (e.g., trial-and-error manual searching through millions of stored messages, manual cross-referencing of public market data against private order entry messaging, manual calculation of order book levels and other metadata fields per message, etc.). In some instances, abusive behavior may escape detection altogether until or unless investigators are alerted to the suspected abuse through, for example, a complaint lodged by a market participant who observed anomalous activity on a given day between certain times in connection with a particular contract. Once alerted, investigators may then begin the painstaking process of manually examining all the relevant messages received within the identified timeframe in an attempt to isolate and identify the abusive behavior.

### BRIEF DESCRIPTION OF THE DRAWINGS

FIG. 1 shows a block diagram of a representative system 100 for detecting potential abusive trading behavior in an electronic market in accordance with the present teachings.

FIG. 2 shows a flow chart of a representative process 200 for detecting potential abusive trading behavior in an electronic market in accordance with the present teachings.

FIG. 3 shows a flow chart depicting exemplary operation of the system 100 of FIG. 1.

FIG. 4 shows a representative general computer system 400 for use with a system in accordance with the present teachings.

### DETAILED DESCRIPTION

High-frequency trading (HFT) is typically characterized by rapid entry and cancellation of orders via an automated trading system (ATS) in response to dynamic market conditions. Exchanges and regulators tend to regard HFT—and algorithmic trading (AT) in general—as potential sources of concern in light of the relative novelty of these practices and the heightened media focus they receive. By way of example, regulators have alleged that high-frequency traders may engage in “abusive” trading patterns that are not necessarily inspired by dynamic fundamental and/or technical trading conditions. Heretofore, detection of abusive behavior in HFT has been difficult and resource-intensive, and typically involves laborious manual investigative procedures.

Methods and systems for detecting potential abusive trading behavior in electronic markets have been discovered and are described herein. In some embodiments, the present teachings may be used in the context of regulatory surveillance programs. However, the present teachings are applicable in all manner of electronically traded markets.

Throughout this description and in the appended claims, the following definitions are to be understood:

The phrase “fundamental” as used to describe a market event, trading conditions, and/or the like refers to a type of analysis based on economic data.

The phrase “technical” as used to describe a market event, trading conditions, and/or the like refers to a type of analysis based on price movement.

The phrase “coupled with” is defined to mean directly connected to or indirectly connected through one or more intermediate components. Such intermediate components may include both hardware and software based components.

As used in the pending claims and to hereby provide notice to the public, the phrases “at least one of <A>, <B>, . . . and <N>” or “at least one of <A>, <B>, . . . <N>, or combinations thereof” are defined in the broadest sense, superseding any other implied definitions herebefore or hereinafter unless expressly asserted to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While some embodiments described herein may make reference to the CME, it is to be understood that the present teachings are in no way restricted to the CME or, for that matter, to any specific Exchange. On the contrary, the present teachings are applicable to any Exchange, including but not limited to ones that trade in equities and/or other securities.

It is to be understood that elements and features of the various representative embodiments described below may be combined in different ways to produce new embodiments that likewise fall within the scope of the present teachings.

By way of general introduction, a method for detecting potential abusive trading behavior in an electronic market in accordance with the present teachings comprises: (a) querying a database in response to an alert signifying a possible trading irregularity, wherein the database is configured to store data mined from one or a plurality of electronic social media platforms; (b) determining whether the database contains evidence of a news event that explains the trading irregularity and, if so, whether the news event corresponds to fundamental and/or technical market activity; and (c) flagging the trading irregularity as potential abusive trading behavior if the database contains evidence of the news event but it is determined that the news event does not correspond to fundamental and/or technical market activity.

In some embodiments, a method in accordance with the present teachings further comprises one or a plurality of the following additional acts: (d) receiving the alert identifying the trading irregularity as being potential abusive trading behavior; (e) communicating to a regulatory entity that the trading irregularity likely represents abusive trading behavior; (f) implementing a limitation on an account associated with a market participant suspected of abusive trading behavior; (g) concluding that the trading irregularity likely does not represent abusive trading behavior; (h) discarding the alert identifying the trading irregularity as being potential abusive trading behavior; (i) selecting a discarded alert for further analysis to confirm that that the trading irregularity does not represent abusive trading behavior; (j) determining that the database does not contain evidence of the news event; (k) identifying a source behind the trading irregularity as having previously triggered other alerts precipitated by one or more social media communications associated with the source; (l) flagging the trading irregularity as potential abusive trading behavior; and/or (m) updating the database with information to improve future impact scoring of the data stored in the database.

In some embodiments, a method for detecting potential abusive trading behavior in an electronic market in accordance with the present teachings is implemented using a computer and, in some embodiments, one or a plurality of the acts of (a) querying, (b) determining, (c) flagging, (d) receiving; (e) communicating; (f) implementing; (g) concluding; (h) discarding; (i) selecting; (j) determining; (k) identifying; (l) flagging; and/or (m) updating described above are performed by one or a plurality of processors.

In some embodiments, methods for detecting potential abusive trading behavior in an electronic market in accordance with the present teachings are configured to utilize a modular approach to implementing cross-correlated pattern recognition between two different sources of information—trading-related data and public media-related data—each of which is enormous in size. Theoretically, all of these data may be placed on the same platform and a pattern recognition algorithm applied on the joint dataset. However, such an approach would involve a substantial computational burden. By contrast, in accordance with the present teachings, pattern recognition may be segregated into two parts to be performed independently and in parallel. By performing the pattern recognition independently and in parallel, one or more of the following benefits may be observed: (a) the efficiency of the pattern recognition may be improved for each; (b) the computational burden may be reduced since joint pattern recognition will only be performed when a potential trading abuse alert is detected; and/or (c) the tractability of further improvements to the algorithm may be improved since each module of the search may be improved over time independent of one another (e.g., an optimization technique known as dimension reduction).

In some embodiments, the news event comprises a legitimate occurrence. In some embodiments, the news event comprises a sham (e.g., a mere rumor with no basis in truth, such as the occurrence of a terrorist attack on an iconic building, death of a public figure, etc.). In some embodiments, the news event comprises a combination of a legitimate occurrence and a sham.

In some embodiments, the legitimate occurrence corresponds to fundamental and/or technical market activity (e.g., an announcement of a company's earnings, a declaration of bankruptcy, a merger of companies, a change in company leadership, and/or the like—each of which is a verifiable and actual event). In some embodiments, the sham does not correspond to fundamental and/or technical market activity.

All manner of social media platforms are contemplated for use in accordance with the present teachings, including but not limited to those that are yet to be developed. Representative social media platforms for use in accordance with the present teachings include but are not limited to 43 Things, Academiu.edu, Advogato, allobii, AsianAvenue, aSmallWorld, Athlinks, Audimated.com, Bebo, Biip.no, BlackPlanet, Blauk, Blogster, Bolt.com, Busuu, Buzznet, CafeMom, Care2, CaringBridge, Classmates.com, Cloob, CouchSurfing, CozyCot, Cross.tv, Crunchyroll, Cyworld, DailyBooth, DailyStrength, delicious, deviantART, Diaspora*, Disaboom, Dol2 day, DontStayln, douban, Draugiem.lv, DXY.cn, Elftown, Elixio, English, baby!, Eons.com, Epernicus, eToro, Experience Project, Exploroo, Facebook, Faceparty, Faces.com, Fetlife, FilmAffinity, Filmow, FledgeWing, Flickr, Flixster, Focus.com, Formspring, Fotki, Fotolog, Foursquare, Friendica, Friends Reunited, Friendster, Frühstückstreff, Fubar, Fuelmyblog, FullCircle, Gaia Online, GamerDNA, gapyear.com, Gather.com, Gays.com, Geni.com, GetGlue, Gogyoko, Goodreads, Goodwizz, Google+, GovLoop, Grono.net, Habbo, hi5, Hospitality Club, Hotlist, HR.com, Hub Culture, Hyves, Ibibo, Identi.ca, Indaba Music, IRC-Galleria, italki.com, Itsmy, iWiW, Jaiku, Jiepang, Kaixin001, Kiwibox, Lafango, LaiBhaari, Last.fm, LibraryThing, Lifenot, LinkedIn, LinkExpats, Listography, LiveJournal, Livemocha, Makeoutclub, MEETin, Meettheboss, Meetup website), MillatFacebook, mixi, Mocospace, MOG, MouthShut.com, Mubi, My Opera, MyHeritage, MyLife, Myspace, Nasza-klasa.pl, Netlog, Nexopia, NGO Post, Ning, Odnoklassniki, Open Diary, Orkut, Outeverywhere, Partyflock, PatientsLikeMe, Pingsta, Pinterest, Plaxo, Playfire, Playlist.com, Plurk, Qapacity, Quechup, Qzone, Raptr, Ravelry, Renren, ReverbNation.com, Ryze, ScienceStage, ShareTheMusic, Shelfari, Sina Weibo, Skoob, Skyrock, SocialVibe, Sonico.com, SoundCloud, Spaces, Stickam, Students Circle, Network, StudiVZ, Stickam, Students Circle Network, StudiVZ, StumbleUpon, Tagged, Talkbiznow, Taltopia, Taringa!, TeachStreet, TermWiki, The Sphere, Touchtalent, TravBuddy.com, Travellerspoint, tribe.net, Trombi.com, Tuenti, Tumblr, Twitter, Tylted, Vampirefreaks.com, Viadeo, Virb, Vkontakte, Vox, Wattpad, WAYN, We Heart It, WeeWorld, Wellwer, WeOurFamily, Wepolls.com, Wer-kennt-wen, weRead, Wiser.org, Wooxie, WriteAPrisoner.com, Xanga, XING, Xt3, Yammer, Yelp, Inc., Zoo.gr, Zooppa, and the like, and combinations thereof.

In some embodiments, the social media platform is selected from the group consisting of Twitter, Facebook, Tumblr, Instagram, LinkedIn, Myspace, Foursquare, Pinterest, Wordpress, Yelp, Reddit, Google+, Qype, and the like, and combinations thereof. In some embodiments, the social media platform comprises Twitter.

In some embodiments, the data stored in the database is refined using statistical analysis which, in some embodiments, comprises message impact scoring. By way of example, for embodiments in which the social media platform comprises Twitter, the statistical analysis may comprise identifying data as being influential or non-influential. In some embodiments, identifying data as being influential or non-influential is based on criteria selected from the group consisting of number of times a tweet is retweeted, number of times the tweet is favorited, follower count of an entity who generated the tweet, number of entities who ultimately receive and/or are exposed to the tweet, whether the tweet is and/or becomes a trending topic, level of user activity generated in response to the tweet, and the like, and combinations thereof.

In some embodiments, as described above, the present teachings provide methods for detecting potential abusive trading behavior in an electronic market. In other embodiments, as further described below, the present teachings also provide systems for detecting potential abusive trading behavior in an electronic market.

By way of example, a first system for detecting potential abusive trading behavior in an electronic market in accordance with the present teachings comprises a processor coupled to a non-transitory memory, wherein the processor is operative to execute computer program instructions to cause the processor to: (a) query a database in response to an alert signifying a possible trading irregularity, wherein the database is configured to store data mined from one or a plurality of electronic social media platforms; (b) determine whether the database contains evidence of a news event that explains the trading irregularity and, if so, whether the news event corresponds to fundamental and/or technical market activity; and (c) flag the trading irregularity as potential abusive trading behavior if the database contains evidence of the news event but it is determined that the news event does not correspond to fundamental and/or technical market activity.

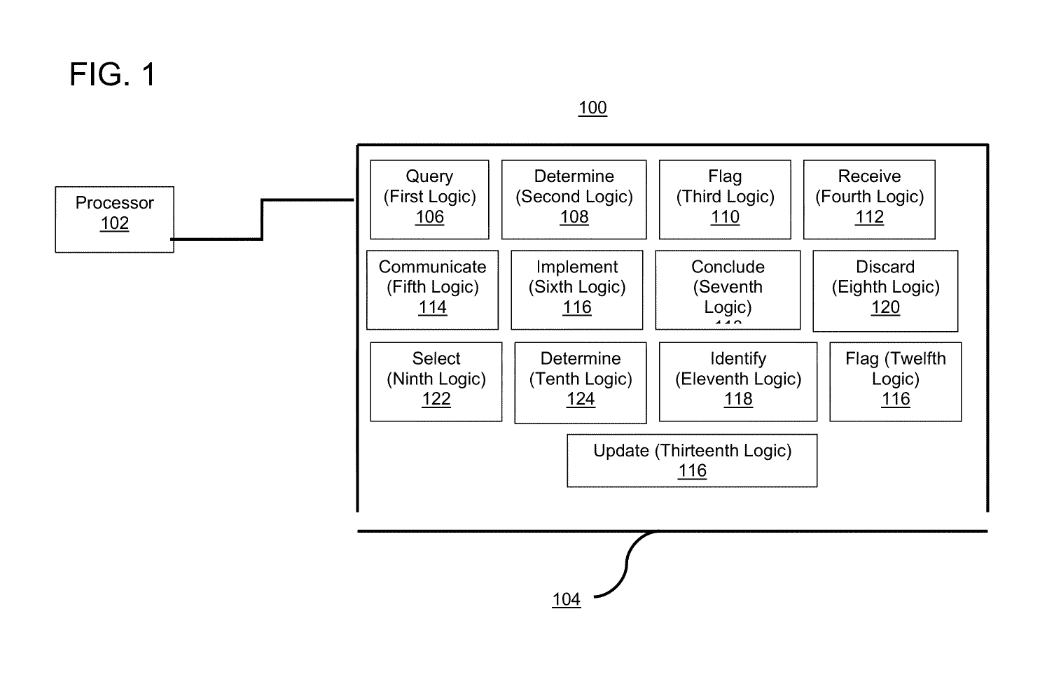

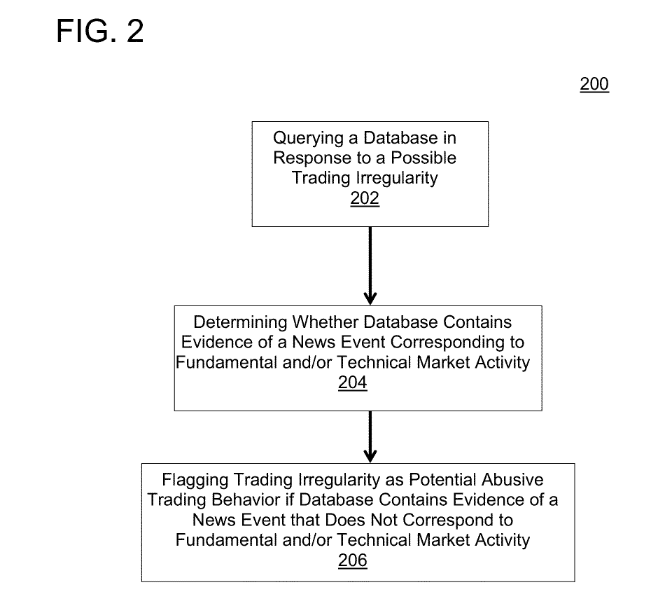

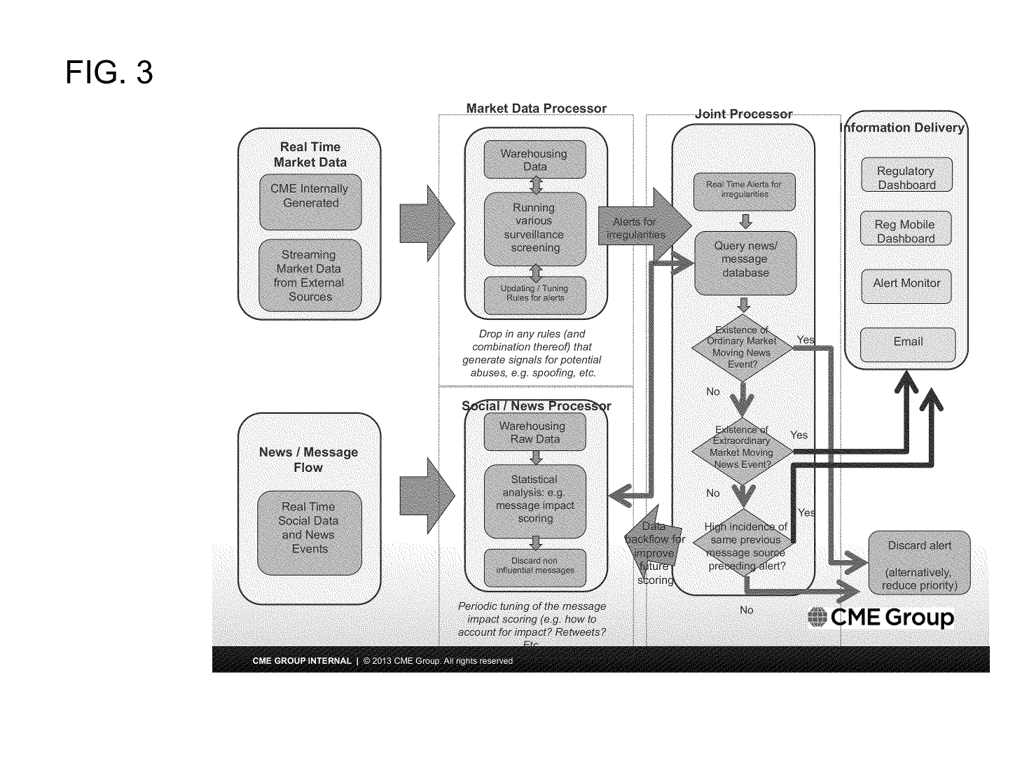

Further aspects of the present teachings will now be described in reference to the drawings. FIG. 1 shows a block diagram of a representative system 100 for detecting potential abusive trading behavior in an electronic market in accordance with the present teachings. FIGS. 2 and 3 depict flow charts showing exemplary operation of the representative system 100 shown in FIG. 1 for detecting potential abusive trading behavior in an electronic market.

In some embodiments, as shown in FIG. 1, a system 100 for detecting potential abusive trading behavior in an electronic market in accordance with the present teachings is implemented as part of an abuse detection module in a computer system. As shown in FIG. 1, the system 100 comprises: a processor 102; a non-transitory memory 104 coupled with the processor 102; (a) first logic 106 stored in the non-transitory memory 104 and executable by the processor 102 to cause the processor 102 to query a database in response to an alert signifying a possible trading irregularity, wherein the database is configured to store data mined from one or a plurality of electronic social media platforms; (b) second logic 108 stored in the non-transitory memory 104 and executable by the processor 102 to cause the processor 102 to determine whether the database contains evidence of a news event that explains the trading irregularity and, if so, whether the news event corresponds to fundamental and/or technical market activity; (c) third logic 110 stored in the non-transitory memory 104 and executable by the processor 102 to cause the processor 102 to flag the trading irregularity as potential abusive trading behavior if the database contains evidence of the news event but it is determined that the news event does not correspond to fundamental and/or technical market activity; (d) fourth logic 112 stored in the non-transitory memory 104 and executable by the processor 102 to cause the processor 102 to receive the alert identifying the trading irregularity as being potential abusive trading behavior; (e) fifth logic 114 stored in the non-transitory memory 104 and executable by the processor 102 to cause the processor 102 to communicate to a regulatory entity that the trading irregularity likely represents abusive trading behavior; (f) sixth logic 116 stored in the non-transitory memory 104 and executable by the processor 102 to cause the processor 102 to implement a limitation on an account associated with a market participant suspected of abusive trading behavior; (g) seventh logic 118 stored in the non-transitory memory 104 and executable by the processor 102 to cause the processor 102 to conclude that the trading irregularity likely does not represent abusive trading behavior; (h) eighth logic 120 stored in the non-transitory memory 104 and executable by the processor 102 to cause the processor 102 to discard the alert identifying the trading irregularity as being potential abusive trading behavior; (i) ninth logic 122 stored in the non-transitory memory 104 and executable by the processor 102 to cause the processor 102 to select a discarded alert for further analysis to confirm that that the trading irregularity does not represent abusive trading behavior; (j) tenth logic 124 stored in the non-transitory memory 104 and executable by the processor 102 to cause the processor 102 to determine that the database does not contain evidence of the news event; (k) eleventh logic 118 stored in the non-transitory memory 104 and executable by the processor 102 to cause the processor 102 to identify a source behind the trading irregularity as having previously triggered other alerts precipitated by one or more social media communications associated with the source; (l) twelfth logic 116 stored in the non-transitory memory 104 and executable by the processor 102 to cause the processor 102 to flag the trading irregularity as potential abusive trading behavior; and (m) thirteenth logic 116 stored in the non-transitory memory 104 and executable by the processor 102 to cause the processor 102 to update the database with information to improve future impact scoring of the data stored in the database.

In some embodiments, the system 100 may be coupled to other modules of a computer system and/or to databases so as to have access to relevant information as needed (e.g., databases storing real time and/or historical market data; databases storing social media news and message flows, etc.) and initiate appropriate actions.

FIG. 2 depicts a flow chart showing exemplary operation of the system 100 of FIG. 1. In particular, FIG. 2 shows a computer-implemented method 200 for detecting potential abusive trading behavior in an electronic market in accordance with the present teachings that comprises: (a) querying 202, by a processor, a database in response to an alert signifying a possible trading irregularity, wherein the database is configured to store data mined from one or a plurality of electronic social media platforms; (b) determining 204, by the processor, whether the database contains evidence of a news event that explains the trading irregularity and, if so, whether the news event corresponds to fundamental and/or technical market activity; and; and (c) flagging 206, by the processor, the trading irregularity as potential abusive trading behavior if the database contains evidence of the news event but it is determined that the news event does not correspond to fundamental and/or technical market activity.

It is to be understood that the relative ordering of some acts shown in the flow chart of FIG. 2 is meant to be merely representative rather than limiting, and that alternative sequences may be followed. Moreover, it is likewise to be understood that additional, different, or fewer acts may be provided, and that two or more of these acts may occur sequentially, substantially contemporaneously, and/or in alternative orders.

FIG. 3 shows a more detailed flow chart depicting exemplary operation of a system for detecting potential abusive trading behavior in an electronic market in accordance with the present teachings. As shown in FIG. 3, in some embodiments, market data (“Real Time Market Data”) stored in a database may be used to develop and/or refine rules that generate signals for potential abuses (“Market Data Processor”). As further shown in FIG. 3, social media data and news events (“News/Message Flow”) stored in a database may be analyzed for impact scoring (“Social/News Processor”). As further shown in FIG. 3, data flows back-and-forth between a database housing social media data mined from one or more social media platforms (“Social/News Processor”) and a system in accordance with the present teachings (“Joint Processor”). As a result of this two-way flow, future scoring of social media messages may be improved. The decision block in FIG. 3 that asks if there is a “high incidence of same previous message source preceding alert?” refers to a situation in which there are a large number (where “large” is defined over time as the system “learns” via two-way flow and the like) of previous potential alerts generated from the market data side also coinciding with (or preceded by) detected social media events (or flags) initiated by the same or a similar set of tweeters, even if alerts were not sent before. In short, the system is configured to search for patterns in an effort to gauge how suspicious certain behavior may be. As shown in FIG. 3, behavior deemed to be suspicious and/or warranting further investigation may be reported to an Exchange and/or other regulatory body (“Information Delivery”). In some embodiments, the block labeled “Discard Alert” in FIG. 3 may correspond to assigning a reduced priority to a particular alert indicating to investigators that further investigation thereof may be unnecessary and/or may be postponed since the likelihood of the underlying behavior representing abusive trading behavior is deemed low.

A third system for detecting potential abusive trading behavior in an electronic market comprises: means for querying a database in response to an alert signifying a possible trading irregularity, wherein the database is configured to store data mined from one or a plurality of electronic social media platforms; means for determining whether the database contains evidence of a news event that explains the trading irregularity and, if so, whether the news event corresponds to fundamental and/or technical market activity; and means for flagging the trading irregularity as potential abusive trading behavior if the database contains evidence of the news event but it is determined that the news event does not correspond to fundamental and/or technical market activity.

A non-transitory computer-readable storage medium in accordance with the present teachings has stored therein data representing instructions executable by a programmed processor for detecting potential abusive trading behavior in an electronic market. The storage medium comprises instructions for: (a) querying a database in response to an alert signifying a possible trading irregularity, wherein the database is configured to store data mined from one or a plurality of electronic social media platforms; (b) determining whether the database contains evidence of a news event that explains the trading irregularity and, if so, whether the news event corresponds to fundamental and/or technical market activity; and (c) flagging the trading irregularity as potential abusive trading behavior if the database contains evidence of the news event but it is determined that the news event does not correspond to fundamental and/or technical market activity.

In some embodiments, the present teachings provide methods and systems for detecting and/or limiting abusive trading practices in an electronic market (e.g., HFT) and, in some embodiments, to doing so by monitoring and comparing typical trading patterns to activity levels in social media message traffic. In some embodiments, methods in accordance with the present teachings monitor typical patterns of trading activity and compare those patterns with traffic on one or a plurality of social media platforms (including but not limited to Twitter). By correlating typical patterns with social media message traffic, the Exchange may be able to identify potential abusive trading practices.

Methods and systems in accordance with the present teachings may offer an advantage of linking fundamental and/or technical market events, as expressed in social media traffic, to market activity. As may be appreciated, there are virtually countless fundamental and technical events that may be deemed significant or at least worthy of action by various traders. Thus, it would be exceedingly difficult, if not impossible, for an Exchange or regulatory body to become aware of each and every such event. However, by referencing social media traffic in accordance with the present teachings, such events may be linked with market activity on an automated and quantitative basis without the necessity of monitoring fundamental and technical events on a qualitative basis, which would be economically unfeasible. Reference to social media as an indication of fundamental and/or technical market activity provides a realistic solution to the Exchange's otherwise inability to monitor for all possible fundamental or technical events.

In some embodiments, methods in accordance with the present teachings seek to identify trading patterns that are not inspired by dynamic fundamental and/or technical trading conditions. In some embodiments, methods in accordance with the present teachings may be used (e.g., by an Exchange and/or regulatory body) to monitor and then attempt to correlate activity along two parallel paths: (1) market data (e.g., both real time and/or historic) and (2) social media traffic.

Market participants frequently utilize social media to engage in conversations regarding fundamental and/or technical market activity. If fundamental or technical events are occurring, or are on the verge of occurring, social media traffic regarding the market in question may increase as a result. Legitimate trading activity is most frequently inspired by fundamental and/or technical market events and, therefore, the volume of trading message traffic may be highly correlated with such market activity. Thus, in some embodiments, methods in accordance with the present teachings “scrape” message traffic regarding the market in question from social media platforms including but not limited to Twitter and/or similar systems.

In some embodiments, a method in accordance with the present teachings first identifies the typical volume and frequency of trading activity engaged in by each active account in a particular market of interest (e.g., by collecting and analyzing real time and/or historical market data) and identifies any patterns that emerge. In some embodiments, any patterns that emerge may be described empirically by one or more of the following: volume and/or rapidity of message traffic, ratio of entered orders to filled orders, the ratio of entered orders to cancelled orders, and the like. In some embodiments, these patterns may be unique to each account in each market.

In some embodiments, patterns will emerge that link trading activity with social media interest. In some embodiments, if the trading activity increases beyond typical or normal volumes or ratios relative to the volume of social media traffic, this may provide an indication that a particular trader is engaging in trading activity that is not ostensibly linked with fundamental and/or technical market events. Although such a discovery does not provide direct evidence of a market abuse, the information may be nonetheless utilized by an Exchange and/or other regulatory body as an indication that further investigation of the nature of such trading activity may be warranted.

In some embodiments, the Exchange may take action by (1) flagging the account for potential future regulatory investigation, (2) placing the account of the market participant suspected of abusive trading behavior in a heightened risk mode, (3) instituting more restrictive credit controls on the account through the Clearing House, and/or the like, and/or combinations thereof.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an Exchange for financial instruments.

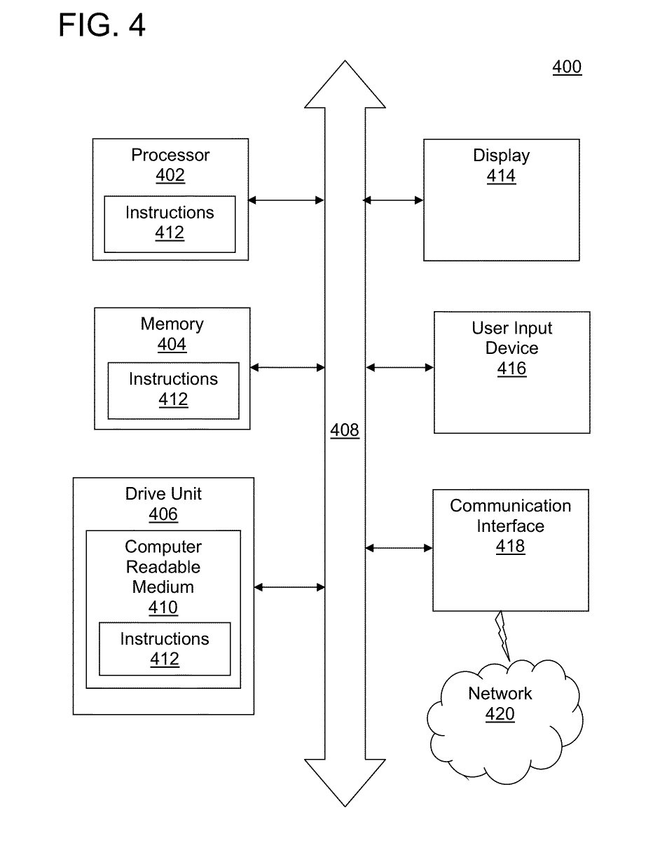

FIG. 4 depicts an illustrative embodiment of a general computer system 400. The computer system 400 can include a set of instructions that can be executed to cause the computer system 400 to perform any one or more of the methods or computer based functions disclosed herein. The computer system 400 may operate as a standalone device or may be connected (e.g., using a network) to other computer systems or peripheral devices. Any of the components discussed above, such as the processor, may be a computer system 400 or a component in the computer system 400. The computer system 400 may implement an order-grouping engine on behalf of an Exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As shown in FIG. 4, the computer system 400 may include a processor 402, for example a central processing unit (CPU), a graphics-processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (CD), digital video disc (DVD), memory card, memory stick, floppy disc, universal serial bus (USB) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 4, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, as shown in FIG. 4, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In some embodiments, as shown in FIG. 4, the computer system 400 may also include a disk or optical drive unit 406. The disk drive unit 406 may include a computer-readable medium 410 in which one or more sets of instructions 412 (e.g., software) can be embedded. Further, the instructions 412 may embody one or more of the methods or logic as described herein. In some embodiments, the instructions 412 may reside completely, or at least partially, within the memory 404 and/or within the processor 402 during execution by the computer system 400. The memory 404 and the processor 402 also may include computer-readable media as described above.

The present teachings contemplate a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of subject matter described in this specification can be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination thereof).

In some embodiments, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations can include distributed processing, component/object distributed processing, and parallel processing. Alternatively, virtual computer system processing can be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, some embodiments of subject matter described herein can be implemented on a device having a display, for example a CRT (cathode ray tube) or LCD (liquid crystal display) monitor, for displaying information to the user and a keyboard and a pointing device, for example a mouse or a trackball, by which the user can provide input to the computer. Other kinds of devices can be used to provide for interaction with a user as well. By way of example, feedback provided to the user can be any form of sensory feedback (e.g., visual feedback, auditory feedback, or tactile feedback); and input from the user can be received in any form, including but not limited to acoustic, speech, or tactile input.

Embodiments of subject matter described herein can be implemented in a computing system that includes a back-end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include but are not limited to a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A computer-implemented method for detecting potential abusive trading behavior in an electronic market, the method comprising:
querying, by a processor, a database in response to an alert signifying a possible trading irregularity, wherein the database is configured to store data mined from one or a plurality of electronic social media platforms;
determining, by the processor, whether the database contains evidence of a news event that explains the trading irregularity and, if so, whether the news event corresponds to fundamental and/or technical market activity; and
flagging, by the processor, the trading irregularity as potential abusive trading behavior if the database contains evidence of the news event but it is determined that the news event does not correspond to fundamental and/or technical market activity.

2. The computer-implemented method of claim 1 further comprising receiving, by the processor, the alert identifying the trading irregularity as being potential abusive trading behavior.

3. The computer-implemented method of claim 1 further comprising communicating, by the processor, to a regulatory entity that the trading irregularity likely represents abusive trading behavior.

4. The computer implemented method of claim 1 further comprising implementing, by the processor, a limitation on an account associated with a market participant suspected of abusive trading behavior.

5. The computer-implemented method of claim 1 further comprising:
communicating, by the processor, to a regulatory entity that the trading irregularity likely represents abusive trading behavior; and
implementing, by the processor, a limitation on an account associated with a market participant suspected of abusive trading behavior.

6. The computer-implemented method of claim 1 further comprising concluding, by the processor, that the trading irregularity likely does not represent abusive trading behavior.

7. The computer-implemented method of claim 6 further comprising discarding, by the processor, the alert identifying the trading irregularity as being potential abusive trading behavior.

8. The computer-implemented method of claim 7 further comprising selecting, by the processor, a discarded alert for further analysis to confirm that that the trading irregularity does not represent abusive trading behavior.

9. The computer-implemented method of claim 1 wherein the news event comprises a legitimate occurrence, a sham, or a combination thereof.

10. The computer-implemented method of claim 9 wherein the legitimate occurrence corresponds to fundamental and/or technical market activity, and wherein the sham does not correspond to fundamental and/or technical market activity.

11. The computer-implemented method of claim 1 further comprising:
receiving, by the processor, the alert identifying the trading irregularity as being potential abusive trading behavior;
determining, by the processor, that the database does not contain evidence of the news event;
identifying, by the processor, a source behind the trading irregularity as having previously triggered other alerts precipitated by one or more social media communications associated with the source; and
flagging, by the processor, the trading irregularity as potential abusive trading behavior.

12. The computer-implemented method of claim 1 further comprising updating, by the processor, the database with information to improve future impact scoring of the data stored in the database.

13. The computer-implemented method of claim 1 wherein the social media platform is selected from the group consisting of Twitter, Facebook, Tumblr, Instagram, LinkedIn, Myspace, Foursquare, Pinterest, Wordpress, Yelp, Reddit, Google+, Qype, and combinations thereof.

14. The computer-implemented method of claim 1 wherein the social media platform comprises Twitter.

15. The computer-implemented method of claim 1 wherein the data stored in the database is refined using statistical analysis.

16. The computer-implemented method of claim 15 wherein the statistical analysis comprises message impact scoring.

17. The computer-implemented method of claim 15 wherein the social media platform comprises Twitter, and wherein the statistical analysis comprises identifying data as being influential or non-influential based on criteria selected from the group consisting of number of times a tweet is retweeted, number of times the tweet is favorited, follower count of an entity who generated the tweet, number of entities who ultimately receive the tweet, whether the tweet is and/or becomes a trending topic, level of user activity generated in response to the tweet, and combinations thereof.

18. A system for detecting potential abusive trading behavior in an electronic market, the system comprising:
a processor;
a non-transitory memory coupled with the processor;
first logic stored in the non-transitory memory and executable by the processor to cause the processor to query a database in response to an alert signifying a possible trading irregularity, wherein the database is configured to store data mined from one or a plurality of electronic social media platforms;
second logic stored in the non-transitory memory and executable by the processor to cause the processor to determine whether the database contains evidence of a news event that explains the trading irregularity and, if so, whether the news event corresponds to fundamental and/or technical market activity; and
third logic stored in the non-transitory memory and executable by the processor to cause the processor to flag the trading irregularity as potential abusive trading behavior if the database contains evidence of the news event but it is determined that the news event does not correspond to fundamental and/or technical market activity.

19. The system of claim 18 further comprising fourth logic stored in the non-transitory memory and executable by the processor to cause the processor to receive the alert identifying the trading irregularity as being potential abusive trading behavior.

20. The system of claim 18 further comprising fifth logic stored in the non-transitory memory and executable by the processor to cause the processor to communicate to a regulatory entity that the trading irregularity likely represents abusive trading behavior.

21. The system of claim 18 further comprising sixth logic stored in the non-transitory memory and executable by the processor to cause the processor to implement a limitation on an account associated with a market participant suspected of abusive trading behavior.

22. The system of claim 18 further comprising:
fifth logic stored in the non-transitory memory and executable by the processor to cause the processor to communicate to a regulatory entity that the trading irregularity likely represents abusive trading behavior; and
sixth logic stored in the non-transitory memory and executable by the processor to cause the processor to implement a limitation on an account associated with a market participant suspected of abusive trading behavior.

23. The system of claim 18 further comprising seventh logic stored in the non-transitory memory and executable by the processor to cause the processor to conclude that the trading irregularity likely does not represent abusive trading behavior.

24. The system of claim 23 further comprising eighth logic stored in the non-transitory memory and executable by the processor to cause the processor to discard the alert identifying the trading irregularity as being potential abusive trading behavior.

25. The system of claim 24 further comprising ninth logic stored in the non-transitory memory and executable by the processor to cause the processor to select a discarded alert for further analysis to confirm that that the trading irregularity does not represent abusive trading behavior.

26. The system of claim 18 wherein the news event comprises a legitimate occurrence, a sham, or a combination thereof.

27. The system of claim 26 wherein the legitimate occurrence corresponds to fundamental and/or technical market activity, and wherein the sham does not correspond to fundamental and/or technical market activity.

28. The system of claim 18 further comprising:
fourth logic stored in the non-transitory memory and executable by the processor to cause the processor to receive the alert identifying the trading irregularity as being potential abusive trading behavior;
tenth logic stored in the non-transitory memory and executable by the processor to cause the processor to determine that the database does not contain evidence of the news event;
eleventh logic stored in the non-transitory memory and executable by the processor to cause the processor to identify a source behind the trading irregularity as having previously triggered other alerts precipitated by one or more social media communications associated with the source; and
twelfth logic stored in the non-transitory memory and executable by the processor to cause the processor to flag the trading irregularity as potential abusive trading behavior.

29. The system of claim 18 further comprising thirteenth logic stored in the non-transitory memory and executable by the processor to cause the processor to update the database with information to improve future impact scoring of the data stored in the database.

30. The system of claim 1 wherein the social media platform is selected from the group consisting of Twitter, Facebook, Tumblr, Instagram, LinkedIn, Myspace, Foursquare, Pinterest, Wordpress, Yelp, Reddit, Google+, Qype, and combinations thereof.

31. The system of claim 18 wherein the social media platform comprises Twitter.

32. The system of claim 18 wherein the data stored in the database is refined using statistical analysis.

33. The system of claim 32 wherein the statistical analysis comprises message impact scoring.

34. The system of claim 33 wherein the social media platform comprises Twitter, and wherein the statistical analysis comprises identifying data as being influential or non-influential based on criteria selected from the group consisting of number of times a tweet is retweeted, number of times the tweet is favorited, follower count of an entity who generated the tweet, number of entities who ultimately receive the tweet, whether the tweet is and/or becomes a trending topic, level of user activity generated in response to the tweet, and combinations thereof.

35. A system for detecting potential abusive trading behavior in an electronic market, the system comprising:
means for querying a database in response to an alert signifying a possible trading irregularity, wherein the database is configured to store data mined from one or a plurality of electronic social media platforms;
means for determining whether the database contains evidence of a news event that explains the trading irregularity and, if so, whether the news event corresponds to fundamental and/or technical market activity; and
means for flagging the trading irregularity as potential abusive trading behavior if the database contains evidence of the news event but it is determined that the news event does not correspond to fundamental and/or technical market activity.

36. In a non-transitory computer-readable storage medium having stored therein data representing instructions executable by a programmed processor for detecting potential abusive trading behavior in an electronic market, the storage medium comprising instructions for:
querying a database in response to an alert signifying a possible trading irregularity, wherein the database is configured to store data mined from one or a plurality of electronic social media platforms;
determining whether the database contains evidence of a news event that explains the trading irregularity and, if so, whether the news event corresponds to fundamental and/or technical market activity; and
flagging the trading irregularity as potential abusive trading behavior if the database contains evidence of the news event but it is determined that the news event does not correspond to fundamental and/or technical market activity.
